(19) United States
(12) Patent Application Publication
(10) Pub. No.: US 2009/0229916 A1
(43) Pub. Date: Sep. 17, 2009

(54) Collapsible Tree Stand

(76) Inventor: Ronald L. Berkbuegler, Troy, IL (US)

Correspondence Address: SENNIGER POWERS LLP, 100 NORTH BROADWAY, 17TH FLOOR, ST LOUIS, MO, 63102, US

(21) Appl. No.: 12/403,201

(22) Filed: Mar. 12, 2009

Related U.S. Application Data
(60) Provisional application No. 61/035,766, filed on Mar. 12, 2008.

(51) Int. Cl. A01M 31/02; A45F 3/26; E04G 3/00; E04G 5/14

(52) U.S. Cl. 182/113; 182/132

(57) ABSTRACT

A collapsible tree stand includes a generally rigid first locking arm releasably locking a first platform in an extended position in which the first platform extends rearward from and generally transverse to the mounting frame. A second platform is secured to a lower portion of the mounting frame for movement toward and away from the mounting frame. A generally rigid second locking arm releasably locks the second platform in an extended position in which the second platform extends forward from and generally transverse to the mounting frame. The mounting frame, first platform and second platform are relatively moveable to a collapsed position in which the first and second platforms generally overlie one another.

### CROSS-REFERENCE TO RELATED APPLICATION

This application claims priority to U.S. Provisional Application No. 61/035,766, filed Mar. 12, 2008, the entirety of which is herein incorporated by reference.

### FIELD OF THE INVENTION

The present invention generally relates to a collapsible tree stand.

### BACKGROUND

Tree stands are used to elevate a user, such as a hunter, in a tree. Tree stands may include a seat and a footrest, and may be secured to a ladder extending downward from the stand. Because the tree stand must support the weight of the user, tree stands should be sturdy and rigid. However, the need to make the tree stand sturdy and rigid often leads to tree stands being bulky and cumbersome to transport, especially when walking through wooded area.

### SUMMARY

In one aspect, a collapsible tree stand for securing to a tree trunk to support a user at an elevated position on the tree trunk generally comprises a mounting frame and a first platform secured to an upper portion of the mounting frame for movement toward and away from the mounting frame. A generally rigid first locking arm releasably locks the first platform in an extended position in which the first platform extends rearward from and generally transverse to the mounting frame. A second platform is secured to a lower portion of the mounting frame for movement toward and away from the mounting frame. A generally rigid second locking arm releasably locks the second platform in an extended position in which the second platform extends forward from and generally transverse to the mounting frame. The mounting frame, first platform and second platform are relatively moveable to a collapsed position in which the first and second platforms generally overlie one another.

Other objects and features will be in part apparent and in part pointed out hereinafter.

### BRIEF DESCRIPTION OF THE DRAWINGS

FIG. 1 is a perspective of a collapsible tree stand with a removable ladder attached thereto;

FIG. 2 is a enlarged, fragmentary view of the tree stand in FIG. 1 showing a seat locking arm and a footrest locking arm secured to a bracket of the tree stand;

FIG. 3 is similar to FIG. 1 with the hand rails, the safety rail and locking pins exploded from the tree stand and the ladder removed;

FIG. 4 is similar to FIG. 3 with the hand rails, safety rail and locking pins removed and the seat locking arms and the footrest locking arms partially retracted;

FIG. 5 is a similar to FIG. 4 with the tree stand being partially collapsed; and

FIG. 6 is a perspective of the tree stand fully collapsed.

Corresponding reference characters indicate corresponding parts throughout the drawings.

### DETAILED DESCRIPTION OF THE DRAWINGS

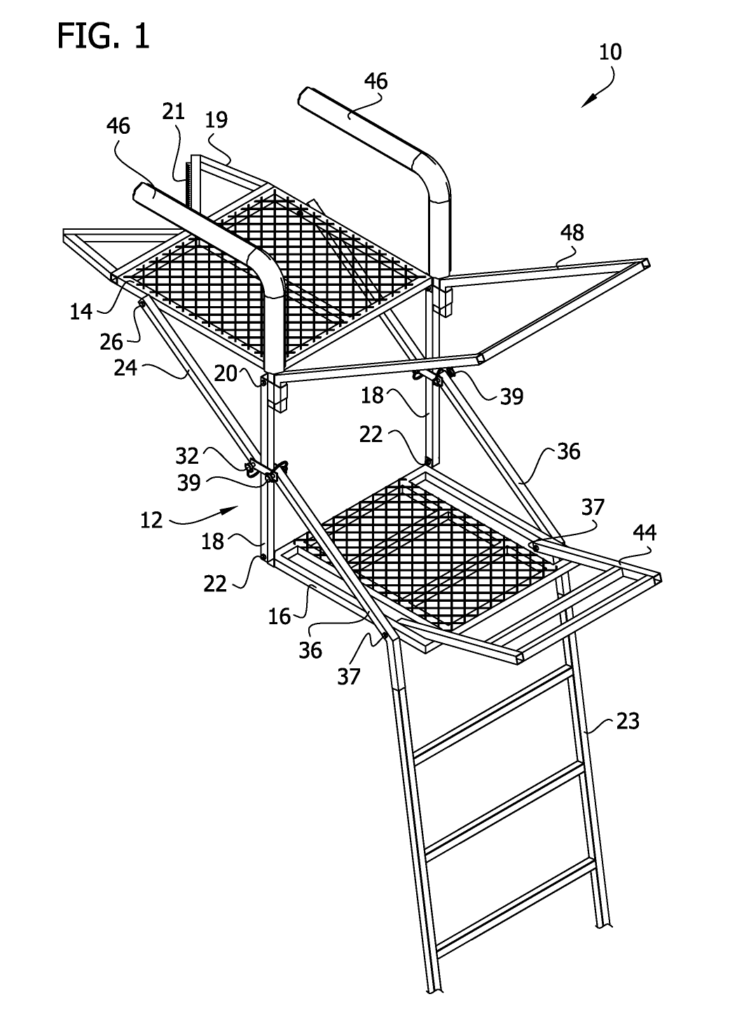

Referring to the drawings, a collapsible tree stand for securement to a tree trunk to support a user at an elevated position on the tree trunk is generally indicated at 10. The tree stand includes a mounting frame, generally indicated at 12, a seat platform 14 (broadly, a first platform) pivotally secured to an upper portion of the mounting frame, and a footrest platform 16 (broadly, a second platform) pivotally secured to a lower portion of the mounting frame. The mounting frame 12 comprises a pair of spaced apart, generally parallel support posts 18. The seat platform 14 is secured between the support posts 18 by seat pivot fasteners 20 (e.g., bolts) to allow the seat platform to pivot toward and away from the mounting frame 12. The footrest platform 16 is also secured between the support posts 18 by footrest pivot fasteners 22 (e.g., bolts) to allow the footrest platform to pivot toward and away from the mounting frame 12. The mounting frame 12 may be constructed of metal, such as steel tubular stock, or other rigid material. The seat platform 14 and the footrest platform 16 may include gratings, on which the user sits and rests his/her feet, respectively. The gratings may be constructed of metal, such as steel or other material. A tree brace 19 projects rearwardly from the seat platform 14. The tree brace 19 has serrated portions 21 arranged in a “V” shape that engage and grip a tree trunk (not shown). Only one of two serrated portions may be seen in the drawings. In FIG. 1, a ladder 23 is attached to the tree stand 10.

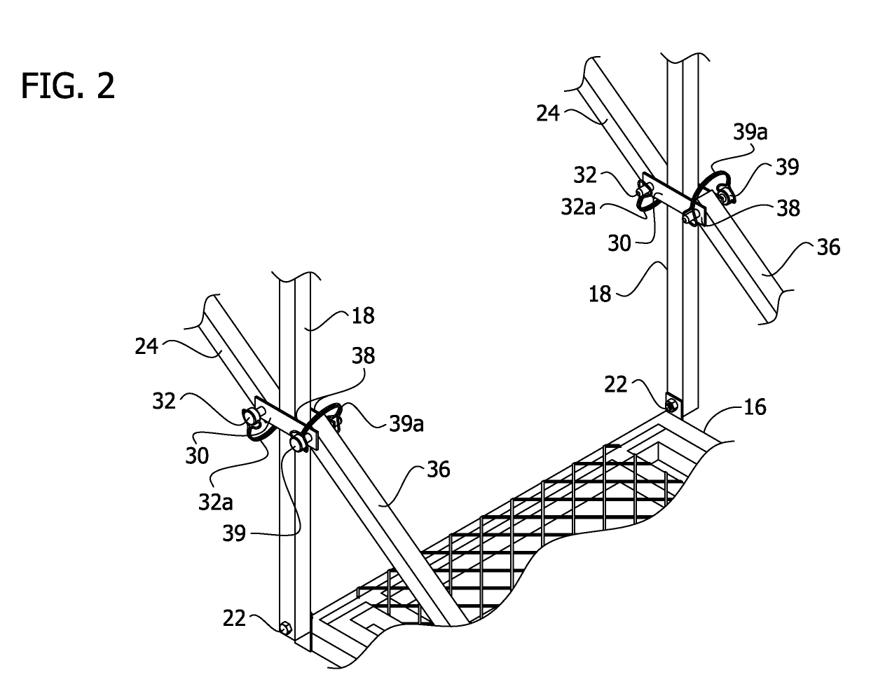

Generally rigid seat locking arms 24 (broadly, first locking arms) secured to opposite lateral sides of the seat platform 14 allow the seat platform to be selectively retained in an extended position, in which the seat platform extends rearward from and generally transversely to the mounting frame 12. The seat locking arms 24 may be constructed of metal, such as tubular steel stock, or other rigid material. Each seat locking arm 24 has a first end margin pivotally secured to the respective side of the seat platform 14 by an arm pivot fastener 26 (e.g., bolt), and a second end margin removably secured to the mounting frame 12 by a first bracket 30 and a removable first locking pin 32 (FIG. 2). The locking pins 32 each have a retaining loop 32a. Each first bracket 30 is fixedly secured in a suitable manner such as by welding to the mounting frame 12 at an intermediate location between the connection locations of the seat platform 14 and the footrest platform 16. The second end margin of each seat locking arm 24 is received in the first bracket 30 so that a transverse opening 33 extending through the seat locking arm is generally aligned with openings 34 extending through the bracket. The first locking pins 32 are slidably and removably received through the respective aligned openings 33, 34 to secure the seat locking arm 24 to the mounting frame 12 and retain the seat platform 14 in the extended position. It is contemplated that the seat locking arms 24 may be releasably secured to the seat platform 14 and pivotally secured to the mounting frame 12. Moreover, it is also contemplated that the seat locking arms 24 may be releasably secured to both the seat platform 14 and the mounting frame 12. Other ways of releasably securing the seat locking arms 24 to at least one of the mounting frame 12 and the seat platform 14 are within the scope of the present invention.

Similar to the seat platform 14, generally rigid footrest locking arms 36 (broadly, second locking arms) secured to opposite sides of the footrest platform 16 to allow the footrest platform to be selectively retained in an extended position, in which the footrest platform extends forward from and generally transversely to the mounting frame 12. The footrest locking arms 36 may be constructed of metal, such as steel tubular stock, or other rigid material.

The footrest locking arms 36 are functionally and structurally substantially the same as the seat locking arms 24, and therefore, reference is made to the description of the seat locking arms. Briefly, the footrest locking arms 36 have first end margins pivotally secured to the footrest platform 16 by arm pivot fasteners 37 and second end margins releasably secured to the mounting frame 12. The footrest locking arms 36 are secured to the mounting frame 12 by second brackets 38 on the mounting frame 12, which are formed integrally with the first bracket 30 associated with the seat locking arms 24, described above. It is to be understood that the first and second brackets 20, 28 may be separate within the scope of the present invention. Removable second locking pins 39 are slidably and removably received through respective aligned openings 40, 42 in the footrest locking arms 36 and the brackets 43 to secure the footrest locking arms to the mounting frame 12 and retain the footrest platform 16 in the extended position. The second locking pins 39 each include a retaining loop 39a. Portions of the first end margins of the footrest locking arms 36 extending beyond the arm pivot fasteners 37 are bent downwardly and configured to receive swaged portions at the upper ends of the stiles of the ladder 23 so that the stand 10 can be used with a ladder.

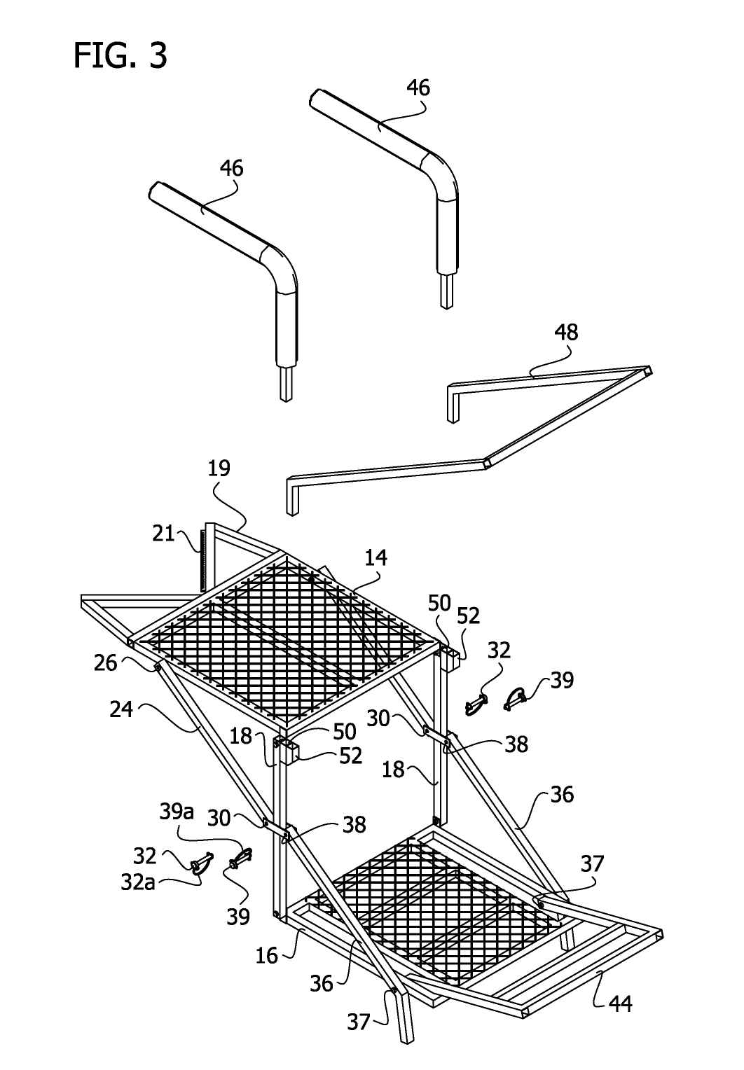

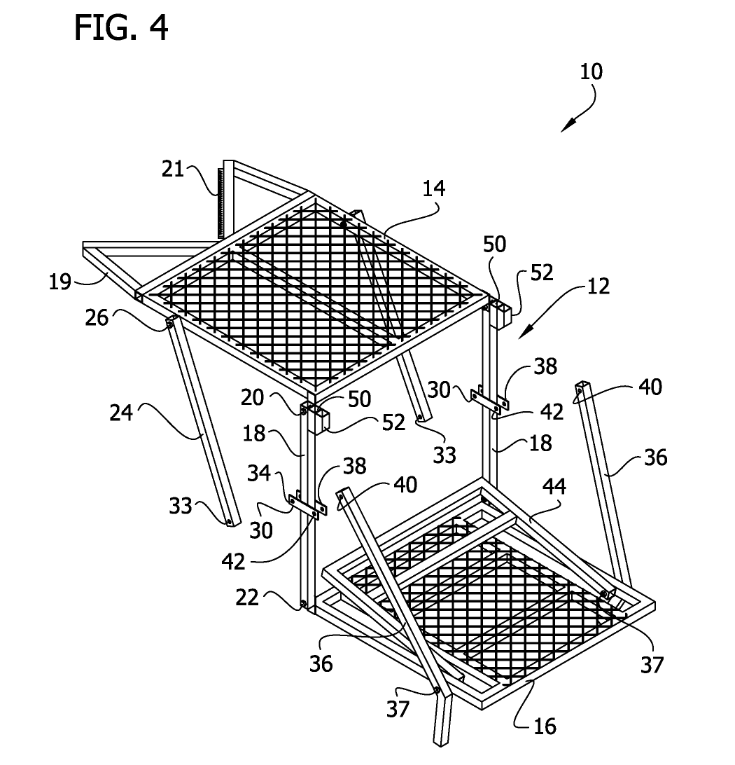

The footrest platform 16 also includes an extension member 44 pivotally secured to the footrest platform by the arm pivot fasteners 37. The extension member 44 is pivotal between an extended position, in which the member extends generally forward from the footrest platform 16 (FIGS. 1 and 3), and a collapsed position, in which the extension member is pivoted rearward and lies generally on top of the footrest platform (FIGS. 4-6).

Referring to FIGS. 1 and 3, the tree stand 10 also includes a pair of hand rails 46 removably secured to the mounting frame 12 and a U-shaped safety rail 48 removable secured to the mounting frame. Respective hand rail and safety rail mounts 50, 52 are secured to the upper portion of the mounting frame 12 and define respective openings for removably receiving respective ones of the hand rails 46 and the safety rail 48. The hand rails 46 and the safety rail 48 may be generally rigid and constructed from metal, such as tubular steel stock, or from other rigid material. The hand rails 46 may include padding.

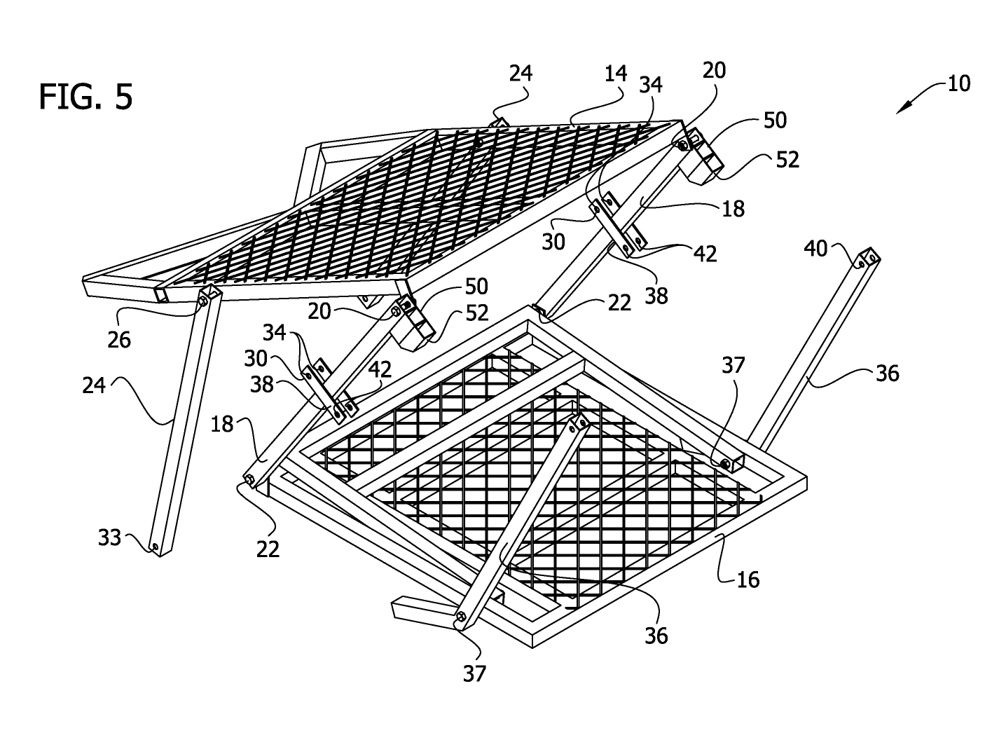

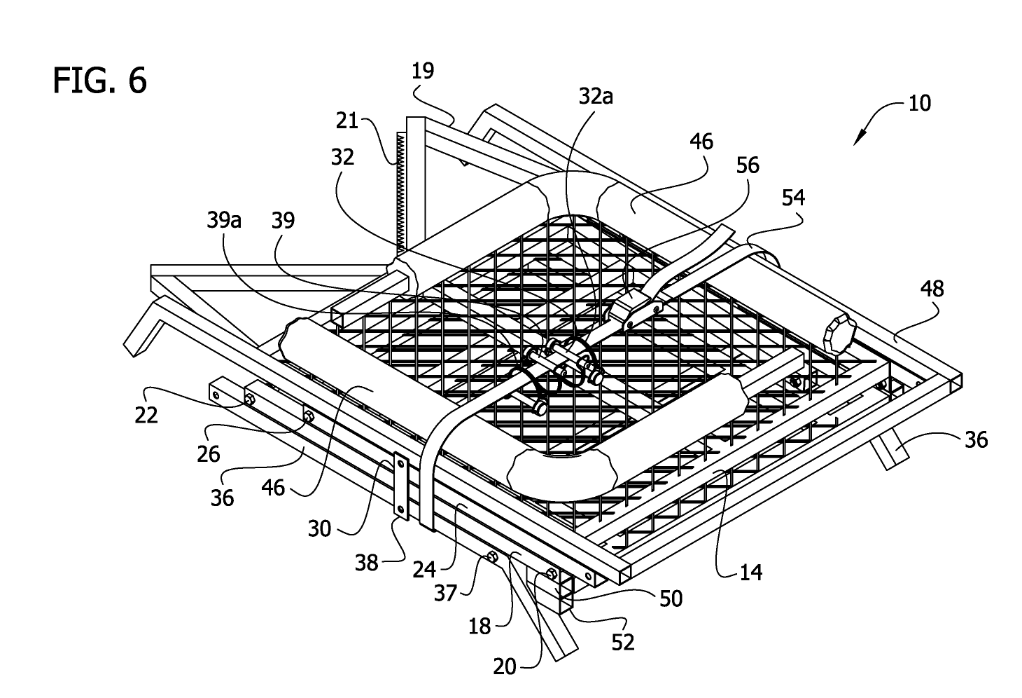

As can be appreciated, the tree stand 10 is collapsible into a compact configuration for use in transporting the stand and can be easily and quickly erected and collapsed. For example, to collapse the stand 10, the hand rails 46 and the safety rail 48 are withdrawn from the respective mounts 50, 52, such as by lifting up on the respective rails (FIG. 3). Next, the locking pins 32, 39 are removed from the respective first and second brackets 30, 38 and the respective locking arms 24, 36. With the locking pins 32, 39 removed, the seat platform 14, the footrest platform 16, the seat locking arms 24 and the footrest locking arms 36 are free to pivot. Referring to FIGS. 5 and 6, the seat platform 14 and the footrest platform 16 can be pivoted toward the mounting frame 12 so that the seat platform and the footrest platform are generally in a stacked or overlying configuration, and the posts 18 of the frame are alongside the seat platform and the footrest platform. The seat and footrest locking arms 24, 36 are pivoted toward the corresponding seat platform and footrest platform so that they are generally parallel to the respective platforms. The hand rails 46, the safety rail 48 and the locking pins 32, 39 are laid on the collapsed stand 10, and a strap 54 is secured around the collapsed stand by a buckle 56 to secure the components together in a bundle. The strap 54 is threaded through the retaining loops 32a, 29a of the first and second locking pins 23, 29 to retain the locking pins in the collapsed assembly. The first and second brackets 20, 28 are disposed to engage other components of the tree stand to restrain them from lateral movement in the collapsed position.

The stand 10 is easily erected by pivoting the seat platform 14 and the footrest platform 16 outward from the mounting frame 12. The seat locking arms 24 and the footrest locking arms 36 are pivoted toward the respective first and second brackets 30, 38 and secured to the brackets by inserting the respective locking pins 32, 39 through the respective arms and respective brackets. The hand rails 46 and the safety rail 48 may be inserted into the respective hand rail mount 50 and safety rail mount 52. Finally, the erected stand 10 can be mounted on the tree trunk T, such as in manner generally known in the art.

Having described the illustrated embodiment in detail, it will be apparent that modifications and variations are possible without departing from the scope of the invention defined in the appended claims.

When introducing elements of the present invention or the illustrated embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A collapsible tree stand for securing to a tree trunk to support a user at an elevated position on the tree trunk, the tree stand comprising:
a mounting frame;
a first platform secured to an upper portion of the mounting frame for movement toward and away from the mounting frame;
a generally rigid first locking arm for releasably locking the first platform in an extended position in which the first platform extends rearward from and generally transverse to the mounting frame;
a second platform secured to a lower portion of the mounting frame for movement toward and away from the mounting frame; and
a generally rigid second locking arm for releasably locking the second platform in an extended position in which the second platform extends forward from and generally transverse to the mounting frame,
the mounting frame, first platform and second platform being relatively moveable to a collapsed position in which the first and second platforms generally overlie one another.

2. A collapsible tree stand as set forth in claim 1 wherein the first locking arm is pivotally secured to one of the first platform and the mounting frame, and removably secured to the other of the first platform and the mounting frame, and wherein the second locking arm is pivotally secured to one of the second platform and the mounting frame, and removably secured to the other of the second platform and the mounting frame.

3. A collapsible tree stand as set forth in claim 2 wherein a first end margin of the first locking arm is pivotally secured to the first platform and a second end margin of the first locking arm is removably secured to the mounting frame, and wherein a first end margin of the second locking arm is pivotally secured to the second platform and a second end margin of the second locking arm is removably secured to the mounting frame.

4. A collapsible tree stand as set forth in claim 3 wherein the second end margin of the first locking arm has a transverse opening and the second end margin of the second locking arm has a transverse opening, the tree stand further comprising:
a first bracket secured to the mounting frame for receiving the second end margin of the first locking arm, the first bracket having at least one opening alignable with the transverse opening in the first locking arm when the first locking arm is received in the first bracket;
a first locking pin adapted for insertion through the transverse opening in the first locking arm and said at least one opening in the first bracket when the respective openings are aligned to lock the first locking arm to the mounting frame;
a second bracket secured to the mounting frame for receiving the second end margin of the second locking arm, the second bracket having at least one opening alignable with the transverse opening in the second locking arm when the second locking arm is received in the second bracket;
a second locking pin adapted for insertion through the transverse opening in the second locking arm and said at least one opening in the second bracket when the respective openings are aligned to lock the second locking arm to the mounting frame.

5. A collapsible tree stand as set forth in claim 3 wherein the first and second locking pins each include a retaining loop.

6. A collapsible tree stand as set forth in claim 4 wherein the first bracket comprises a pair of first brackets secured adjacent to opposite lateral sides of the mounting frame and extending rearward from the mounting frame,
wherein the first locking pin comprises two first locking pins,
wherein the second bracket comprises a pair of second brackets secured adjacent to the opposite lateral sides of the mounting frame and extending forward from the mounting frame,
wherein the second locking pin comprises two second locking pins.

7. A collapsible tree stand as set forth in claim 6 wherein one of the first brackets is integrally formed with one of the second brackets, and wherein the other of the first brackets is integrally formed with the other of the second brackets.

8. A collapsible tree stand as set forth in claim 1 further comprising at least one of a hand rail and a safety rail for removable securement to the mounting frame.

9. A collapsible tree stand as set forth in claim 8 further comprising at least one mount secured to the mounting frame, wherein said at least one of a hand rail and a safety rail are removably insertable into said at least one mount for removably securement to the mounting frame.

10. A collapsible tree stand as set forth in claim 9 wherein said at least one of a hand rail and a safety rail comprises a pair of hand rails and a safety rail, wherein said at least one mount comprises two mounts defining openings for receiving the pair of hand rails and two mounts defining openings for receiving the safety rail.

11. A collapsible tree stand as set forth in claim 1 further comprising an extension member pivotally secured to the second platform.

12. A collapsible tree stand as set forth in claim 11 wherein the extension member is pivotal between an extended position, in which the extension member extends generally forward from the second platform, and a collapsed position, in which the extension member is pivoted rearward and lies generally on top of the second platform.

13. A collapsible tree stand as set forth in claim 1 wherein the first locking arm comprises a pair of first locking arms adjacent to opposite lateral sides of the mounting frame, and wherein the second locking arm comprises a pair of second locking arms adjacent to the opposite lateral sides of the mounting frame.

14. A collapsible tree stand as set forth in claim 13 wherein end margins of the second locking arms are adapted for securement to a ladder.

15. A collapsible tree stand as set forth in claim 1 wherein the first platform is adapted for use as a seat and the second platform is adapted for use as a footrest.

16. A collapsible tree stand as set forth in claim 1 wherein the mounting frame is arranged relative to the first and second platforms to lie generally parallel with the first and second platforms in the collapsed position.

17. A collapsible tree stand as set forth in claim 4 wherein the first and second brackets are disposed to engaged other components of the tree stand in the collapsed position to restrain relative movement.

18. A collapsible tree stand as set forth in claim 1 wherein the first and second locking arms are arranged to generally overlie each other in the collapsed position.

19. A collapsible tree stand as set forth in claim 1 further comprising a strap adapted to secure the tree stand in the collapsed position.
